(19) United States
(12) Patent Application Publication
(10) Pub. No.: US 2022/0400032 A1
(43) Pub. Date: Dec. 15, 2022

(54) CHANNEL ESTIMATION METHOD, SYSTEM, DEVICE, AND STORAGE MEDIUM

(71) Applicant: Guangzhou City Construction College, Guangzhou (CN)

(72) Inventors: Ho-Hsuan Chang, Guangzhou (CN); Donghua Xuan, Guangzhou (CN)

(21) Appl. No.: 17/392,244

(22) Filed: Aug. 2, 2021

(30) Foreign Application Priority Data
Jun. 7, 2021 (CN) 2021106286708

(51) Int. Cl. H04L 25/02

(52) U.S. Cl. CPC H04L 25/0202

(57) ABSTRACT

Disclosed are a channel estimation method and system, a device, and a storage medium. The method includes: acquiring a channel type and a channel expression under a multi-user environment first, and then according to the channel type, determining a training sequence set, training sequences in the training sequence set being zero circular convolution sequences; and according to the channel type, the channel expression and the training sequence set, determining an output sequence.

### CROSS-REFERENCE TO RELATED APPLICATION

This application is filed on the basis of Chinese patent application No. 2021106286708 filed Jun. 7, 2021, and claims priority of the Chinese patent application, the entire contents of which are incorporated herein by reference.

### TECHNICAL FIELD

The present application relates to the field of communications, and more particularly, to a channel estimation method and system, a device, and a storage medium.

### BACKGROUND

A channel is a medium from a transmitting end to a receiving end in a communication process. In a wireless communication scenario, the receiving end receives a wave from the transmitting end which is modulated by a channel. Therefore, it is necessary to acquire sufficient channel information before starting communication, which means that the channel is estimated, so that a communication system can perform correct signal demodulation at the receiving end. In order to estimate the channel, a known training sequence is generally used to estimate the channel in related art. However, under a multi-user environment, the channel estimation is a difficult task. In related art, a commonly used channel estimation method includes transmitting the known training sequence to the channel at the transmitting end of the communication system, receiving an output result at the receiving end, and according to the output result and the training sequence, estimating unknown channel parameters. A function sequence with an ideal pulse type self-correlation can be used for channel estimation, but these sequences have a correlation therebetween. Therefore, under a multi-user environment, the correlation between sequences will cause inter symbol interference (ISI), which leads to a poor channel estimation effect.

### SUMMARY

The present application aims to solve at least one of the technical problems in related art to some extent. For this purpose, the present application provides a channel estimation method and system, a device, and a storage medium.

In a first aspect, an embodiment of the present application provides a channel estimation method, including: acquiring a channel type, determining a channel expression according to the channel type; determining a training sequence set according to the channel type; determining an output sequence according to the channel type, the channel expression and the training sequence set; and determining an estimation result of a channel according to the training sequence set and the output sequence. The channel type includes at least one of a time selective channel, a frequency selective channel, or a time-frequency mixed channel. The channel is shared by multiple users, and information is transmitted by the users to the channel in a time-sharing and multi-tasking manner. Training sequences in the training sequence set are zero circular convolution sequences, and a cross-correlation function between any two training sequences in the training sequence set is zero.

Optionally, when the channel type is one of the time selective channel and the frequency selective channel, the determining a training sequence set according to the channel type includes: determining a first prototype sequence including multiple elements; performing sequence expansion on the first prototype sequence according to the channel type and determining a first sequence; acquiring m second sequences with a same length as the first sequence, wherein m is a positive integer; determining m third sequences according to the channel type, the first sequence and the second sequence, wherein a set of the m third sequences is the training sequence set.

The first prototype sequence meets the following formula:

Rₛ=E·δ_{P}[p],

where s represents the first prototype sequence, P represents a length of the first prototype sequence, P is a positive integer, Rₛ is a self-correlation function of the first prototype sequence, E is an average power of the first prototype sequence s, δ_{L}[l] represents a pulse sequence function with a length of L, and p represents a p^{th} element.

An expression of the second sequence is as follows:

eₖ={exp(j2πkn/N)}ₙ₌₀^{N-1}, 0≤k≤m−1,

where eₖ is a second sequence, j represents an imaginary part of a complex number, k represents a k^{th} element in eₖ, N is a length of the second sequence, N is a positive integer, and a value of n is [0, N−1].

Optionally, the performing sequence expansion on the first prototype sequence according to the channel type and determining a first sequence includes: if the channel type is the time selective channel, stacking the first prototype sequence for m times in sequence, and determining the first sequence suitable for the time selective channel; and if the channel type is the frequency selective channel, respectively adding m−1 zeros after each element of the first prototype sequence, and determining the first sequence suitable for the frequency selective channel.

Optionally, the determining m third sequences according to the channel type, the first sequence and the second sequence includes: if the channel type is the time selective channel, respectively multiplying each component in the first sequence by the second sequence, and determining m third sequences suitable for the time selective channels; and if the channel type is the frequency selective channel, respectively multiplying each component in a discrete Fourier transform (DFT) of the first sequence by the second sequence, and determining m third sequences suitable for the frequency selective channel.

Optionally, when the channel type is the time-frequency mixed channel, the determining a training sequence set according to the channel type includes: taking the first sequence as a second prototype sequence; performing sequence expansion on the second prototype sequence according to the channel type and determining a fourth sequence; acquiring m second sequences with a same length as the fourth sequence; and determining m fifth sequences according to the fourth sequence and the second sequence, wherein a set of the m fifth sequences is the training sequence set.

Optionally, determining the m fourth sequences according to the second prototype sequence and the second sequence includes: if the second prototype sequence is the first sequence suitable for the frequency selective channel, respectively adding m−1 zeros after each element of the second prototype sequence, and determining the fourth sequence; and if the second prototype sequence is the first sequence suitable for the time selective channel, stacking the second prototype sequence for m times in sequence, and determining the fourth sequence.

Optionally, the determining an output sequence according to the channel type, the channel expression and the training sequence set includes: if the channel is the time selective channel, inputting a DFT of the training sequence into the channel, and determining the output sequence; and if the channel is the frequency selective channel, inputting the training sequence into the channel, and determining the output sequence.

In a second aspect, an embodiment of the present application provides a channel estimation system, including: an acquisition module configured for acquiring a channel type, and determining a channel expression according to the channel type; wherein the channel type includes a time selective channel, a frequency selective channel and a time-frequency mixed channel; the channel is shared by multiple users, and information is transmitted by the users to the channel in a time-sharing and multi-tasking manner; a training sequence construction module configured for determining a training sequence set according to the channel type, wherein a cross-correlation function between any two training sequences in the training sequence set is zero; a modulation module configured for determining an output sequence according to the channel type, the channel expression and the training sequence set; and a channel estimation module configured for determining an estimation result of the channel according to the training sequence set and the output sequence.

In a third aspect, an embodiment of the present application provides a device, including: at least one processor; and at least one memory for storing at least one program. The at least one program, when executed by the at least one processor, causes the at least one processor to implement the channel estimation method in the first aspect.

In a fourth aspect, an embodiment of the present application provides a computer storage medium storing a program executable by a processor, wherein the program executable by the processor, when executed by the processor, is configured for implementing the channel estimation method in the first aspect.

The embodiments of the present application have the following beneficial effects: the channel type and the channel expression under a multi-user environment are acquired first, and then according to the channel type, the training sequence set is determined; training sequences in the training sequence set are the zero circular convolution sequences; and according to the channel type, the channel expression and the training sequence set, the output sequence is determined. In the embodiments of the present application, a channel transmits information in a time-sharing and multi-tasking manner, then sequences received by different users at the same time point are not overlapped; moreover, the channel is estimated by using the training sequence set including the zero circular convolution sequence in the embodiments of the present application, and a cross-correlation function between any two training sequences in the training sequence set is zero; therefore, an inter symbol interference between the sequences received by different users can be effectively suppressed, thus effectively improving an accuracy of channel estimation.

### BRIEF DESCRIPTION OF DRAWINGS

The accompanying drawings are provided to further understand the technical solutions of the present application and constitute a part of the specification. The accompanying drawings are used together with the embodiments of the present application to explain the technical solutions of the present application, but are not intended to limit the technical solutions of the present application.

FIG. 1 is a flow chart of steps of a channel estimation method provided by an embodiment of the present application;

FIG. 2 is a flow chart of steps of constructing a zero circular convolution sequence provided by the embodiment of the present application;

FIG. 3 is a flow chart of steps of constructing a zero circular convolution sequence in a time-frequency mixed domain provided by the embodiment of the present application;

FIG. 4 is a schematic diagram of a channel estimation system provided by an embodiment of the present application; and

FIG. 5 shows a device provided by an embodiment of the present application.

### DETAILED DESCRIPTION

To make the objectives, the technical solutions, and the advantages of the present application clearer, the present application is further described in detail hereinafter with reference to the accompanying drawings and the embodiments. It should be understood that the specific embodiments described herein are only used for explaining the present application and are not intended to limit the present application.

It needs to be noted that although the functional modules are divided in the system diagram and the logical sequence is shown in the flow chart, the steps shown or described may be executed by module division different from that in the system or a sequence different from that in the flow chart in some cases. The terms “first”, “second”, etc. in the specification, the claims, and the above accompanying drawings are used to distinguish similar objects, and are not necessarily used to describe a specific order or sequence.

In order to estimate a channel, a known training sequence is generally used to estimate the channel in related art, but under a multi-user environment, channel estimation is a difficult task. In related art, a commonly used channel estimation method includes: transmitting the known training sequence to the channel from a transmitting end of a communication system, receiving an output result at the receiving end, and according to the output result and the training sequence, estimating unknown channel parameters. These training sequences are generally required to have an orthogonal characteristic to obtain a better channel estimation effect. However, when faced with a complex and time-varying wireless communication scenario, especially a scenario of performing channel estimation for all users under a multi-user environment, typical training sequences have obvious deficiencies in function.

Moreover, from a point of view of sequence design, sequences with an ideal pulse type self-correlation function are called “perfect sequences”, and the perfect sequences may be used for channel estimation, but these sequences have a correlation therebetween. Therefore, under a multi-user environment, the correlation between the sequences may cause an inter symbol interference (ISI), which leads to a poor channel estimation effect.

On this basis, an embodiment of the present application provides a channel estimation method and system, a device, and a storage medium. In the channel estimation method provided by the present application, a training sequence set including a zero circular convolution sequence is transmitted to a channel. Since there are no sequences with an ideal pulse type self-correlation function characteristic and an ideal zero cross-correlation function characteristic at the same time in theory, in the embodiment of the present application, the perfect sequences are used as prototype sequences, sequences with an ideal cross-correlation characteristic are constructed in a time domain, a frequency domain, and a time-frequency mixed domain respectively, and these sequences are called zero circular convolution sequences. The zero circular convolution sequences retain a periodic similar ideal pulse type self-correlation function characteristic, a training sequence set includes the zero circular convolution sequences, and a cross-correlation function between any two sequences in the set is zero. Therefore, an inter symbol interference between the sequences received by different users can be effectively suppressed by using the training sequence set to estimate the channel under a multi-user environment, thus effectively improving an accuracy of channel estimation.

The embodiments of the present application are further described hereinafter with reference to the accompanying drawings.

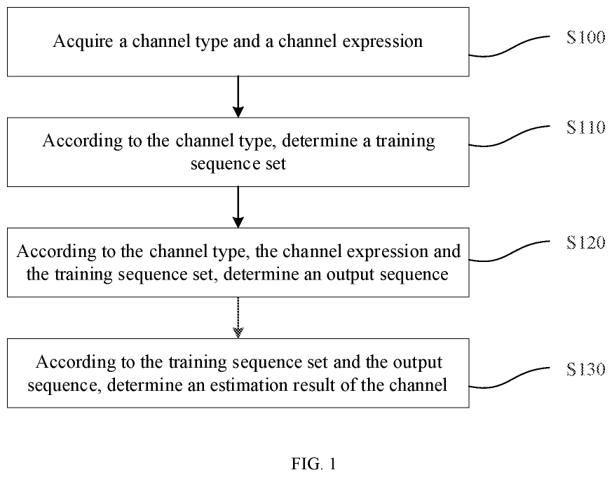

With reference to FIG. 1, FIG. 1 is a flow chart of steps of a channel estimation method provided by an embodiment of the present application. The method includes but is not limited to steps S100 to S130.

In S100, a channel type and a channel expression are acquired.

Specifically, according to stability of channels in a time domain and a frequency domain, the channels may be divided into four types: a channel without time selectivity and frequency selectivity, a channel with frequency selectivity only, a channel with time selectivity only, and a channel with both frequency selectivity and time selectivity. The above four types of channels may also be extended to single-user or multi-user channels, and for the multi-user channels, channel parameter estimation is a difficult task.

In the step, the channel type to be estimated is determined first. It should be noted that, in the embodiment of the present application, three cases of a time selective channel, a frequency selective channel, and a time-frequency mixed channel under a multi-user environment are described, and the channel type is one of the above three cases. According to the acquired channel type, the channel expression is determined. For the frequency selective channel, the channel is simulated as a channel h with N parameters (N-order), with an expression as follows:

h=(h[0],h[l], . . . ,h[N−1]),

where {[h(n)]}ₙ₌₀^{N-1} is deemed as a channel parameter to be estimated. In other words, a value of each item in the channel h may be determined through channel estimation. Under a multi-user environment, for an i^{th} user, the frequency selective channel corresponding to the user may be represented by the following formula:

hᵢ=(hᵢ[0],hᵢ[1], . . . ,hᵢ[N−1]), i=0,1, . . . ,m−1,

wherein, i is a serial number of the user, and m represents that channels of a total of m users to be estimated.

Similarly, for the time selective channel, the channel is simulated as a channel hₜ with N parameters (N-dimension), with an expression as follows:

hₜ=[h₀,h₁, . . . ,h_{N-1}]^{T}

wherein, t refers to a t^{th} parameter, according to hₜ, at an n^{th} time point in the time domain, a value h[n] of the channel hₜ may be represented by the following formula:

$$h [ n ] = {\sum }_{q = 0}^{N - 1} {h}_{q} {e}^{j 2 π qn / N} , n = 0 , 1 , … , N - 1$$

wherein, q represents a q^{th} channel parameter. hₜ=[h₀, h₁, . . . , h_{N-1}]^{T} may be deemed as a DFT form of {h[0], h[1], . . . , h[N−1]}, so that the following formula is established:

$${h}_{q} = {\sum }_{q = 0}^{N - 1} h [ n ] {e}^{j 2 π qn / N} , q = 0 , 1 , … , N - 1$$

Similarly, under a multi-user environment, in order to distinguish the m users to be subjected to channel estimation, the channel expression hₜ may be changed to be represented by hₜ^{k}, and an expression of hₜ^{k} is as follows:

hₜ=[h₀,h₁, . . . ,h_{N-1}]^{T}

wherein, k represents a channel to be estimated of a k^{th} user, and according to hₜ^{k}, at an n^{th} time point in a corresponding time domain, a value hₖ[n] of the channel hₜ^{k} may be represented by the following formula:

$${h}_{k} [ n ] = {\sum }_{q = 0}^{N - 1} {h}_{q}^{k} {e}^{j 2 π qn / N} , n = 0 , 1 , … , N - 1$$

Moreover, the above formula may be represented in a matrix form, which is specifically as follows:

hₖ=[hₖ[0],hₖ[1], . . . ,hₖ[N−1]]^{T}

In other words, hₜ^{k}=[h₀^{k}, h₁^{k}, . . . , h_{N-1}^{k}]^{T} is a DFT of hₖ=[hₖ[0], hₖ[1], . . . , hₖ[N−1]]^{T}.

In S110, according to the channel type, a training sequence set is determined.

Specifically, in the embodiment of the present application, different training sequence sets may be constructed for different channels. In the embodiment of the present application, training sequences in the training sequence set are zero circular convolution sequences, and a cross-correlation function between any two training sequences in the training sequence set is zero. Sequences included in the training sequence set are represented as {z₀, z₁, . . . , zₘ₋₁}, and the zero circular convolution sequences in the training sequence set meet the following expression:

zₖ=z₀·eₖ

wherein, k represents a serial number of the training sequence in the training sequence set, zₖ represents a k^{th} training sequence, z₀ represents a first training sequence, and eₖ meets the following formula:

eₖ={exp(j2πkn/N)}ₙ₌₀^{N-1}, 0≤k≤m−1

{z₀, z₁, . . . , zₘ₋₁} is subjected to DFT, then {Z₀, Z₁, . . . , Z_{N-1}} is obtained. In the present application, the training sequence set {z₀, z₁, . . . , zₘ₋₁} is used for channel estimation. Moreover, a specific construction method of the zero circular convolution sequences will be described hereinafter.

In S120, according to the channel type, the channel expression and the training sequence set, an output sequence is determined.

Specifically, different training sequence sets may be determined according to different channel types, and the training sequence set or a DFT of the training sequence set is transmitted to the channel from a transmitting end. After modulation, a receiving end located at a base station may receive the modulated output sequence. In the embodiment of the present application, the channel includes multiple users, and the multiple users transmit information to the channel in a time-sharing and multi-tasking manner. Meanwhile, individual channels of the multiple users are estimated. Signal transmission of the frequency selective channel and signal transmission of the time selective channel are respectively described hereinafter.

For the frequency selective channel, the m users transmit the training sequence set {z₀, z₁, . . . , zₘ₋₁} to the channel in a time-sharing manner in sequence. With reference to Table 1, Table 1 is a list of training sequences transmitted by users in a time-sharing manner under a multi-user environment. As shown in Table 1, the first row represents time points of time-sharing tasks (t=0, 1, 2, . . . , m−1), and the first column from the left represents serial numbers of users (0, 1, 2, . . . , m−1). In order to avoid confusion, relative channels to be estimated are listed in the last column from the left.

TABLE 1
List of training sequences transmitted by users in
time-sharing manner under multi-user environment

| | t | | | | | |
|---|---|---|---|---|---|---|
| | | | | | | Relative |
| Serial number | | | | | | channel to be |
| of user | 0 | 1 | 2 | . . . | m − 1 | estimated |
| 0 | z₀ | z₁ | z₂ | . . . | zₘ₋₁ | h₀ |
| 1 | z₁ | z₂ | z₃ | . . . | z₀ | h₁ |
| 2 | z₂ | z₃ | z₄ | . . . | z₁ | h₂ |
| . | . | . | . | . . . | . | . |
| . | . | . | . | | . | . |
| . | . | . | . | | . | . |
| m − 1 | zₘ₋₁ | z₀ | z₁ | . . . | zₘ₋₂ | hₘ₋₁ |

With reference to Table 1, taking the user with the serial number 2 as an example (a shading part in Table 1), a channel to be estimated corresponding to the user is h₂, and at the time points t=0, 1, 2, . . . , m−1, h₂ respectively transmits the training sequences z₂, z₃, . . . , zₘ₋₁, z₀, z₁ in sequence. On the other hand, taking the time point t=2 as an example, the sequences z₂, z₃, . . . , zₘ₋₁, z₀, z₁ are respectively assigned to the users with the serial numbers 0, 1, 2, . . . , m−1 as the training sequences, and so on. According to the time-sharing and multi-tasking manner shown in Table 1, all users may be ensured to receive different sequences in the training sequence set in a time-sharing period, and since the sequences in the training sequence set are the zero circular convolution sequences, the cross-correlation function between the sequences is zero, which effectively suppresses an inter symbol interference.

For the frequency selective channel, an output signal {y[n]} is a result of a convolution operation between an input signal {s[n]} and an N-order channel {h[n]}ₙ₌₀^{N-1}. When the user transmits the training sequences {z₀, z₁, . . . , zₘ₋₁} to the channel in the time-sharing and multi-tasking manner, then at the same time, a resultant signal x received by the receiving end of the base station may be represented by the following formula:

$$x = {\sum }_{n = 0}^{m - 1} {h}_{n} {⊗}_{N} {z}_{n} + n$$

x represents an output sequence of the channel, n represents a serial number of the user, hₙ represents the channel of the user, zₙ represents a training sequence corresponding to the user with the serial number n, n represents noise, ⊗_{N} represents circular convolution with a period of N.

Similarly, for the time selective channel, the m users may also transmit information to the channel in the time-sharing and multi-tasking manner shown in Table 1. However, in estimation of the time selective channel, DFTs {Z₀, Z₁, . . . , Z_{N-1}} of the training sequences {z₀, z₁, . . . , zₘ₋₁} are transmitted by the users, and the output signal {y[n]} is a result of direct multiplication of the input signal {s[n]} and the N-order channel {h[n]}. Therefore, the resultant signal x received at the receiving end may be represented by the following formula:

$$x = {\sum }_{n = 0}^{m - 1} {h}_{n} \cdot {z}_{n} + n$$

x represents an output sequence of the channel, and x is subjected to DFT to obtain the following sequence X:

$$X = {\sum }_{n = 0}^{m - 1} {h}_{t}^{n} {⊗}_{N} {z}_{n} + N$$

X represents a DFT result of the output sequence x, and N represents a DFT result of the noise n.

In S130, according to the training sequence set and the output sequence, an estimation result of the channel is determined.

Specifically, according to the known output sequence and the known training sequence, various parameters of the channel may be estimated. In the frequency selective channel, the output signal {y[n]} is a result of a convolution operation between the input signal {s[n]} and the N-order channel {h[n]}ₙ₌₀^{N-1}. Moreover, in the time selective channel, the output signal {y[n]} is a result of direct multiplication of the input signal {s[n]} and the N-order channel {h[n]}. According to different modulation methods, different operations are performed on the output signal {y[n]} and the input signal {s[n]}, then the estimation result {h[n]} of the channel may be obtained. Channel estimation processes of the frequency selective channel and the time selective channel are as follows.

For the frequency selective channel, the output sequence received by the receiving end of the base station is x, the base station is configured with independent m branches, and each branch is configured with sequences {z₋*, z₋₁*, . . . , z₋₍ₘ₋₁₎*}, and circular convolution is performed on the sequences and the output sequence x respectively. Taking a k^{th} branch as an example, a specific calculation formula is as follows:

$$\begin{matrix}x {⊗}_{N} {z}_{- k}^{*} = {\sum }_{n = 0}^{m - 1} ( {h}_{n} {⊗}_{N} {z}_{n} ) {⊗}_{N} {z}_{- k}^{*} + n {⊗}_{N} {z}_{- k}^{*} \\ = {h}_{k} {⊗}_{N} {z}_{k} {⊗}_{N} {z}_{- k}^{*} + n {⊗}_{N} {z}_{- k}^{*}\end{matrix}$$

Since the zero circular convolution sequence used in the embodiment of the present application takes a perfect sequence as a prototype sequence, for a perfect sequence sₚ with p elements, a self-correlation function Rₛ meets the following relationship:

$$\begin{matrix}{R}_{s} = {s}_{p} {⊗}_{N} {s}_{- p}^{*} \\ = {E}_{p} \cdot {δ}_{p} [ p ]\end{matrix}$$

sₚ represents the prototype sequence, p represents a length of the prototype sequence, Rₛ is a self-correlation function of the prototype sequences, Eₚ is an average power of the prototype sequence sₚ, and δₚ represents a pulse sequence function with a length of p.

Then, for a zero circular convolution sequence zₖ, since zₖ is expanded by m second sequences eₖ, a self-correlation function Rₖ meets the following relationship:

$${R}_{k} = {z}_{k} {⊗}_{N} {z}_{- k}^{*} = {mE}_{p} \cdot ( {\overbrace{{\underbrace{1 , 0 , … , 0}}_{p} , {\underbrace{{e}^{j 2 π k / m} , … , 0}}_{p} , {\underbrace{{e}^{j 2 π k 2 / m} , … , 0}}_{p} , … , {\underbrace{{e}^{j 2 π k ( m - 1 ) / m} , … , 0}}_{p}}}^{N = m p} )$$

Therefore, the following formula is established:

$$\begin{matrix}{\sum }_{k = 0}^{m - 1} {z}_{k} {⊗}_{N} {z}_{- k}^{*} = {\sum }_{k = 0}^{m - 1} {R}_{k} \\ = {m}^{2} {E}_{p} \cdot {δ}_{N} [ n ]\end{matrix}$$

Therefore, an expression of performing circular convolution on the sequence x and the sequence z₋ₖ* may be represented as follows:

$$\begin{matrix}x {⊗}_{N} {z}_{- k}^{*} = {h}_{k} ⊗ {\sum }_{k = 0}^{m - 1} {R}_{k} + n {⊗}_{N} {z}_{- k}^{*} \\ = {h}_{k} ⊗ {\sum }_{n = 0}^{m - 1} ( {m}^{2} {E}_{p} \cdot {δ}_{N} [ n ] ) + n {⊗}_{N} {z}_{- k}^{*} \\ = {m}^{2} {E}_{p} \cdot {h}_{k} + n {⊗}_{N} {z}_{- k}^{*}\end{matrix}$$

According to the above formula, a complete signal received by the channel corresponding to the k^{th} user may be completely obtained in m time points of the time-sharing task, and a signal correspondingly received by the k^{th} user has no inter symbol interference. Therefore, for the above formula, an estimation error to be assessed only includes a noise part, and the noise part is determined by

$${\sum }_{k = 0}^{m - 1} {n}_{k} {⊗}_{N} {z}_{- k}^{*} .$$

Therefore, according to the above formula, hₖ to be estimated may be deduced, and a specific expression of hₖ is as follows:

$${\hat{h}}_{k} = \frac{1}{{m}^{2} {E}_{p}} x {⊗}_{N} {z}_{- k}^{*}$$

A specific process of acquiring a channel estimation result in the frequency selective channel is described above, and a process of acquiring a channel estimation result in the time selective channel is described below.

For the time selective channels, DFTs {Z₀, Z₁, . . . , Z_{N-1}} of sequences {z₀, z₁, . . . , zₘ₋₁} are transmitted from the transmitting end, so that the output sequence received at the receiving end is x, and a DFT of x is X. The base station is configured with m independent branches, and each branch is configured with sequence {z₋*, z₋₁*, . . . , z₋₍ₘ₋₁₎*}. For the k^{th} user, X and z₋ₖ* of the corresponding k^{th} branch are subjected to circular convolution to obtain the following expression:

$$\begin{matrix}X {⊗}_{N} {z}_{- k}^{*} = {\sum }_{n = 0}^{m - 1} {h}_{n} {⊗}_{N} {z}_{n} {⊗}_{N} {z}_{- k}^{*} + N {⊗}_{N} {z}_{- k}^{*} \\ = {h}_{t}^{k} {⊗}_{N} {z}_{k} {⊗}_{N} {z}_{- k}^{*} + N {⊗}_{N} {z}_{- k}^{*} \\ = {h}_{t}^{k} {⊗}_{N} {R}_{k} + N {⊗}_{N} {z}_{- k}^{*}\end{matrix}$$

The complete signal received by the channel corresponding to the k^{th} user may be completely obtained in m time points of the time-sharing task, so that the following formula is established:

$$\begin{matrix}{h}_{t}^{k} {⊗}_{N} {\sum }_{n = 0}^{m - 1} {R}_{k} = {h}_{t}^{k} {⊗}_{N} ( {m}^{2} {E}_{p} {δ}_{N} [ n ] ) \\ = {m}^{2} {E}_{p} \cdot {h}_{t}^{k}\end{matrix}$$

Therefore, an expression of performing circular convolution on X and z₋ₖ*, of the k^{th} branch may be represented as follows:

$$\begin{matrix}X {⊗}_{N} {z}_{- k}^{*} = {h}_{t}^{k} {⊗}_{N} {R}_{k} + N {⊗}_{N} {z}_{- k}^{*} \\ = {m}^{2} {E}_{p} \cdot {h}_{t}^{k} + N {⊗}_{N} {z}_{- k}^{*}\end{matrix}$$

For the above formula, an estimation error to be assessed only includes a noise part, and the noise part is determined by

$${\sum }_{k = 0}^{m - 1} {N}_{k} {⊗}_{N} {z}_{- k}^{*} .$$

Therefore, according to the above formula, hₜ^{k} to be estimated may be deduced, and a specific expression of hₜ^{k} is as follows:

$${\hat{h}}_{t}^{k} = \frac{1}{{m}^{2} {E}_{p}} X {⊗}_{N} {z}_{- k}^{*}$$

A process of obtaining the channel estimation results in the time selective channel and the frequency-selective channel has been described in detail above.

Through steps S100 to S130, in the embodiment of the present application, the channel type and the channel expression under a multi-user environment are acquired first, and then according to the channel type, the training sequence set is determined. The training sequence in the training sequence set is the zero circular convolution sequence. According to the channel type, the channel expression and the training sequence set, the output sequence is determined. In the embodiment of the present application, the channel transmits information in the time-sharing and multi-tasking manner, then sequences received by different users at the same time point are not overlapped. Moreover, the channel is estimated by using the training sequence set including the zero circular convolution sequence in the embodiment of the present application, and a cross-correlation function between any two training sequences in the training sequence set is zero; therefore, an inter symbol interference between the sequences received by different users can be effectively suppressed, thus effectively improving an accuracy of channel estimation.

A construction process of the zero circular convolution sequence in the present application is described hereinafter.

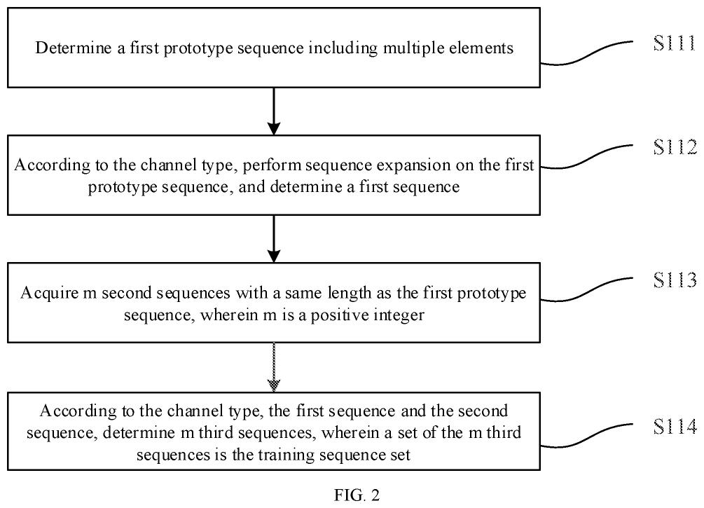

With reference to step S110 in FIG. 1, the step further includes sub-steps of constructing the zero circular convolution sequence. With reference to FIG. 2, FIG. 2 is a flow chart of steps of constructing the zero circular convolution sequence provided by the embodiment of the present application. The method includes but is not limited to steps S111 to S114.

In S111, a first prototype sequence is determined, wherein the first prototype sequence includes multiple elements.

Specifically, the zero circular convolution sequence provided by the embodiment of the present application is constructed by taking the perfect sequence with an ideal pulse type self-correlation function characteristic as the prototype sequence. As mentioned above, for the perfect sequence s, with p elements, a self-correlation function Rₛ meets the following relationship:

$$\begin{matrix}{R}_{s} = {s}_{p} {⊗}_{N} {s}_{- p}^{*} \\ = {E}_{p} \cdot {δ}_{P} [ p ]\end{matrix}$$

The zero circular convolution sequence constructed by the perfect sequence has a periodic similar ideal pulse type self-correlation function characteristic, so that the zero circular convolution sequence can be a sequence used for channel estimation first. In addition, the zero circular convolution sequence also has an ideal cross-correlation characteristic. Assuming that there are two periodic sequences s₁ and s₂ with a length of N, an expression is as follows:

s₁={s₁[n]}ₙ₌₀^{N-1},

s₂={s₂[n]}ₙ₌₀^{N-1}

wherein n represents an n^{th} element, then a cross-correlation function between the sequences s₁ and s₂ is set to be R_{1,2} and an expression of R_{1,2} is as follows:

$$\begin{matrix}{R}_{1 , 2} [ τ ] = {s}_{1} {⊗}_{N} {s}_{- 2}^{*} \\ = {\sum }_{n = 0}^{N - 1} {s}_{1} [ n ] \cdot {s}_{2}^{*} [ {( n - τ )}_{N} ]\end{matrix}$$

wherein τ represents a τ^{th} function of the self-correlation function R_{1,2}, when

$${R}_{1 , 2} [ τ ] = {\sum }_{n = 0}^{N - 1} {s}_{1} [ n ] \cdot {s}_{2}^{*} [ {( n - τ )}_{N} ] = 0 , ∀ τ$$

is established, the sequences s₁ and s₂ are called to have the ideal cross-correlation characteristic, and s₁ and s₂ are called zero circular convolution sequences (ZCC). For the two sequences s₁ and s₂, if an inner product of s₁ and s₂ is zero, which means that s₁ and s₂ meet the following relationship:

$$\begin{matrix}{s}_{1} ⊥ {s}_{2} = {s}_{1} \cdot {s}_{2}^{H} \\ = {\sum }_{n = 0}^{N - 1} {s}_{1} [ n ] {s}_{2}^{*} [ n ] \\ = 0 = {R}_{1 , 2} [ 0 ]\end{matrix}$$

then the sequences s₁ and s₂ are orthogonal. It can be known from the above formula that the sequences s₁ and s₂ are orthogonal in a case that R_{1,2}=0 when τ=0, that is to say, the sequences in the zero circular convolution sequence set have an orthogonal characteristic, and it is more difficult to construct the zero circular convolution sequences than to construct the orthogonal sequences.

Characteristic of the zero circular convolution sequence with the perfect sequence as the prototype sequence is briefly introduced above. In the step, the first prototype sequence meets the following formula:

Rₛ=E·δ_{P}[p]

s represents the first prototype sequence, p represents a length of the first prototype sequence, Rₛ is a self-correlation function of the first prototype sequence, E is an average power of the first prototype sequence s, and δ_{P} represents a pulse sequence function with a length of p, so that the first prototype sequence is the perfect sequence. For convenience of explanation, the first prototype sequence is set to be sₚ, a length of sₚ is p, and a DFT of sₚ is represented by Sₚ, then sₚ and Sₚ are represented by the following formula

sₚ=(sₚ[0],sₚ[1], . . . ,sₚ[p−1])

Sₚ=(Sₚ[0],Sₚ[1], . . . ,Sₚ[p−1])

In S112, according to the channel type, sequence expansion is performed on the first prototype sequence, and a first sequence is determined.

Specifically, according to different channel types, sequence expansion is performed on the first prototype sequence sₚ.

Firstly, for the time selective channel, the first prototype sequence is stacked for m times in sequence to form a first sequence with a length of N=mp, the first sequence is called sₛ, with a DFT of Sₛ, then sₛ and Sₛ are represented by the following formula:

$${s}_{s} = ( {\overbrace{\begin{matrix}{\underbrace{{s}_{p} [ 0 ] , {s}_{p} [ 1 ] , … , {s}_{p} [ p - 1 ]}}_{p} , {\underbrace{{s}_{p} [ 0 ] , {s}_{p} [ 1 ] , … , {s}_{p} [ p - 1 ]}}_{p} , \\ … , {\underbrace{{s}_{p} [ 0 ] , {s}_{p} [ 1 ] , … , {s}_{p} [ p - 1 ]}}_{p}\end{matrix}}}^{N = m p} )$$

$${S}_{s} = m \cdot ( {\overbrace{{\underbrace{{S}_{p} [ 0 ] , 0 , … , 0}}_{m} , {\underbrace{{S}_{p} [ 1 ] , 0 , … , 0}}_{m} , … , {\underbrace{{S}_{p} [ p - 1 ] , 0 , … , 0}}_{m}}}^{N = m p} )$$

It can be known from the expression of Sₛ that, except that Sₛ[n], n=0, m, 2m, . . . , (p−1)m is determined by Sₚ[.] in Sₛ, values of other (m−1)p elements are all zero. According to a first theorem, there is a considerable space in the time domain to construct the zero circular convolution sequence. The first theorem is specifically that: two non-zero sequences s₁ and s₂ have a ZCC characteristic in the time domain, which means that a self-correlation function R_{1,2}=s₁⊗s₋₂*=0 is met. If a DFT of the sequence s₁ is S₁, and a DFT of the sequence s₂ is S₂, then non-zero elements in two sequences S₁ and S₂ are not overlapped, that is to say, S₁·S₂*={S₁[n]S₂*[n]}ₙ₌₀^{N-1} is a zero vector.

If the channel type is the frequency selective channel, m−1 zeros are respectively added after each element of the first prototype sequence. Similarly, the first sequence with a length of N=mp may be formed. For the sake of distinction, the first sequence is called sᵢ, with a DFT of Sᵢ, then sₜ and Sₜ are represented by the following formula:

$${s}_{t} = ( {\overbrace{{\underbrace{{s}_{p} [ 0 ] , 0 , … , 0}}_{m} , {\underbrace{{s}_{p} [ 1 ] , 0 , … , 0}}_{m} , … , {\underbrace{{s}_{p} [ p - 1 ] , 0 , … , 0}}_{m}}}^{N = m p} )$$

$${S}_{t} = ( {\overbrace{\begin{matrix}{\underbrace{{S}_{p} [ 0 ] , {S}_{p} [ 1 ] , … , {S}_{p} [ p - 1 ]}}_{p} , {\underbrace{{S}_{p} [ 0 ] , {S}_{p} [ 1 ] , … , {S}_{p} [ p - 1 ]}}_{p} , \\ … , {\underbrace{{S}_{p} [ 0 ] , {S}_{p} [ 1 ] , … , {S}_{p} [ p - 1 ]}}_{p}\end{matrix}}}^{N = m p} )$$

Since sₜ is a result of respectively adding m−1 zeros after each element of sₚ according to a second theorem, the zero circular convolution sequence may be constructed for sₜ in the frequency domain. The second theorem is specifically that: there are two non-zero sequences s₁ with a DFT being S₁ and s₂ with a DFT being S₂, when s₁ and s₂ have a ZCC characteristic in the frequency domain, which means that a self-correlation function S₁⊗S₋₂*=0 is met, then non-zero elements in two sequences s₁ and s₂ are not overlapped, that is to say, s₁·s₂*={s₁[n]s₂*[n]}ₙ₌₀^{N-1} is a zero vector.

In S113, m second sequences with a same length as the first prototype sequence are acquired, wherein m is a positive integer.

Specifically, an expression of the second sequence is as follows:

eₖ={exp(j2πkn/N)}ₙ₌₀^{N-1}, 0≤k≤m−1

eₖ is the second sequence, N is a length of the second sequence, and N is also a length of the first sequence.

In S114, according to the channel type, the first sequence and the second sequence, m third sequences are determined, wherein a set of the m third sequences is the training sequence set.

Specifically, in the embodiment of the present application, according to different channel types, the zero circular convolution sequences are constructed in the time domain and the frequency domain respectively.

For the time selective channel, each component in the first sequence is multiplied by the second sequence respectively, which means that the above sₛ and eₖ are subjected to a component-wise product. That is, elements at a same position in sₛ and eₖ are multiplied, which is represented by a symbol “·”, m sequences may be obtained after the component-wise product, and these sequences are called third sequences sₛₖ. An expression of the third sequence sₛₖ is as follows:

$$\begin{matrix}{s}_{sk} = {s}_{s} \cdot {e}_{k} \\ = {\{ {s}_{s} [ n ] exp ( j 2 π nk / N ) \}}_{n = 0}^{N - 1}\end{matrix}$$

DFT of the third sequence sₛₖ is represented as Sₛₖ, and Sₛₖ is represented as follows:

$$\begin{matrix}{S}_{sk} = {S}_{s}^{( k )} = {\{ {S}_{k} [ {( n - k )}_{N} ] \}}_{n = 0}^{N - 1} \\ = m \cdot ( {\overbrace{\begin{matrix}{\underbrace{0 , … , 0}}_{k} , {S}_{p} [ 0 ] , {\underbrace{0 , … , 0}}_{m - k - 1} , {\underbrace{0 , … , 0}}_{k} , {S}_{p} [ 1 ] , {\underbrace{0 , … , 0}}_{m - k - 1} , … , \\ {\underbrace{0 , … , 0}}_{k} , {S}_{p} [ p - 1 ] , … , {\underbrace{0 , … , 0}}_{m - k - 1}\end{matrix}}}^{N = m p} )\end{matrix}$$

then according to the above formula, the following relationship is established:

Sₛₖ·Sₛₗ=0, ∀0≤k, l≤m−1, k≠l

according to the above formula, the following two relational expressions are established at the same time:

(sₛ·eₖ)⊗_{N}(sₛ·eₗ)=0

(sₛ·eₖ)⊗_{N}(s₋ₛ*·e₋ₗ*)=0

which means that any two sequences sₛₖ and sₛₗ in a sequence set {sₛ·eₖ} meet the following relationship:

$$\begin{matrix}{R}_{sk , sl} [ τ ] = {s}_{sk} {⊗}_{N} {s}_{- sl}^{*} \\ = {\sum }_{n = 0}^{N - 1} {s}_{sk} [ n ] \cdot {s}_{sl}^{*} [ {( n - τ )}_{N} ] = 0\end{matrix}$$

Therefore, in the sequence set {sₛ·eₖ} including the third sequences sₛₖ, all m sequences have a ZCC characteristic in the time domain therebetween, which is suitable for the time selective channel.

For the frequency selective channel, each component in a DFT of the first sequence is respectively multiplied by the second sequence, which means that the above Sₜ and eₖ are subjected to a component-wise product to obtain m sequences, and these sequences are called third sequences Sₜₖ. An expression of the third sequence Sₜₖ is as follows:

$$\begin{matrix}{S}_{tk} = {S}_{t} \cdot {e}_{k} \\ = {\{ {S}_{t} [ n ] exp ( j 2 π nk / N ) \}}_{n = 0}^{N - 1} , 0 \leq k \leq m - 1\end{matrix}$$

The third sequence Sₜₖ is subjected to inverse DFT (IDFT) to obtain sₜₖ, and an expression of sₜₖ is as follows:

$$\begin{matrix}{s}_{tk} = {s}_{t}^{( k )} = {\{ {s}_{t} [ {( n - k )}_{N} ] \}}_{n = 0}^{N - 1} \\ = m \cdot ( {\overbrace{\begin{matrix}{\underbrace{0 , … , 0}}_{k} , {s}_{p} [ 0 ] , {\underbrace{0 , … , 0}}_{m - k - 1} , {\underbrace{0 , … , 0}}_{k} , {s}_{p} [ 1 ] , {\underbrace{0 , … , 0}}_{m - k - 1} , … , \\ {\underbrace{0 , … , 0}}_{k} , {s}_{p} [ p - 1 ] , … , {\underbrace{0 , … , 0}}_{m - k - 1}\end{matrix}}}^{N = m p} )\end{matrix}$$

According to the above formula, the following relationship is established:

sₜₖ·sₜₗ=0, ∀0≤k, l≤m−1, k≠l

then according to the above formula, the following two relational expressions may be established at the same time:

(Sₜ·eₖ)⊗_{N}(Sₜ·eₗ)=0

which means that any two sequences Sₜₖ and Sₜₗ in the sequence set {Sₜ·eₖ} meet the following relationship:

$$\begin{matrix}{R}_{tk , tl} [ τ ] = {S}_{tk} {⊗}_{N} {S}_{- sl}^{*} \\ = {\sum }_{n = 0}^{N - 1} {S}_{tk} [ n ] \cdot {S}_{t l}^{*} [ {( n - τ )}_{N} ] = 0\end{matrix}$$

Therefore, in the sequence set {Sₜ·eₖ} which includes of the third sequences Sₜₖ, all m sequences have a ZCC characteristic in the frequency domain therebetween, which is suitable for the frequency selective channel.

Through steps S111 to S114, in the embodiment of the present application, a construction process of the zero circular convolution sequence is described from two aspects of time domain and frequency domain, and the zero circular convolution sequence set suitable for the time selective channel or the frequency selective channel is obtained respectively, and the set is the training sequence set in the embodiment of the present application.

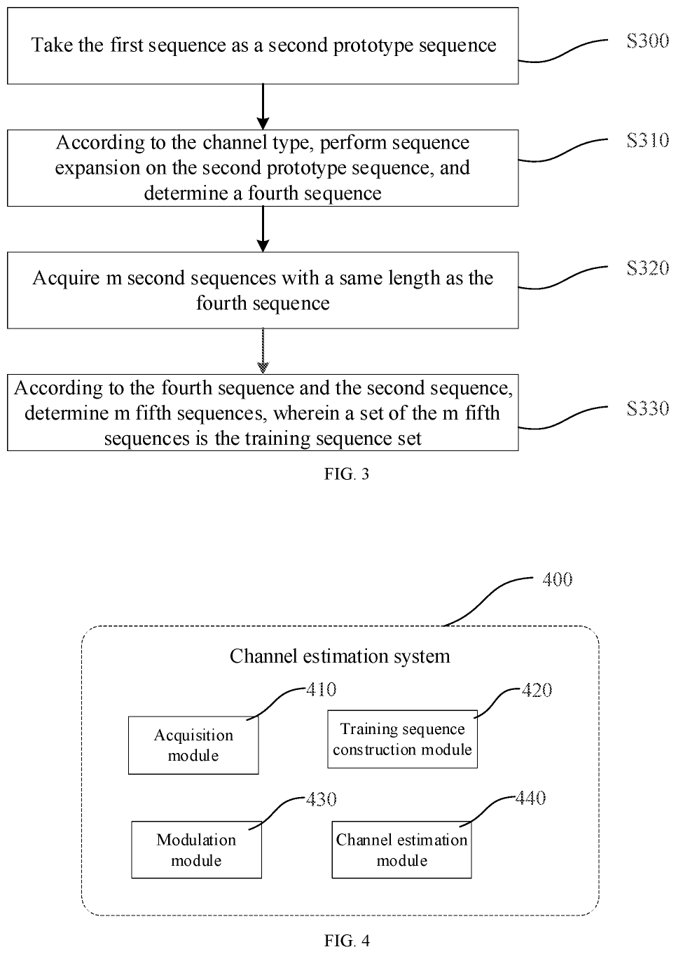

In some embodiments, the zero circular convolution sequence may also be constructed based on the time-frequency mixed domain, and construction steps may be similar to the above construction steps in the time domain and the frequency domain. With reference to FIG. 3, FIG. 3 is a flow chart of steps of constructing the zero circular convolution sequence in the time-frequency mixed domain provided by the embodiment of the present application. The method includes but is not limited to steps S300 to S330.

In S300, the first sequence is used as a second prototype sequence.

Specifically, the first sequence mentioned in the method steps of FIG. 2 is used as the second prototype sequence. For the frequency selective channel, the above first sequence sₛ is used as the second prototype sequence. For the time selective channel, the above first sequence sₜ is used as the second prototype sequence.

In S310, according to the channel type, sequence expansion is performed on the second prototype sequence, and a fourth sequence is determined.

Specifically, according to step S300, different sequence expansion treatments may be performed on sequences suitable for different types of channels. It can be known from the above that a length of the first prototype sequence is set to be p. For the frequency selective channel, m−1 zeros may be added after each element of the second prototype sequence to obtain the fourth sequence with a length of N=m²p. For the time selective channel, the second prototype sequence is stacked m times in sequence to obtain the fourth sequence with the length of N=m² p.

In S320, m second sequences with a same length as the fourth sequence may be acquired.

Specifically, the acquired second sequence has a same form as the second sequence mentioned above, but has a different length. The second sequence in the step is expressed as follows:

eₖ={exp(j2πkn/N)}ₙ₌₀^{N-1}, 0≤k≤m−1

wherein, N=m² p.

In S330, according to the fourth sequence and the second sequence, m fifth sequences may be determined, wherein a set of the m fifth sequences is the training sequence set.

Similar to step S114 in FIG. 2, when the second prototype sequence is sₛ, each element in a DFT of the second prototype sequence is multiplied by the second sequence in step S320 to obtain the m fifth sequences. When the second prototype sequence is sₜ, each element in the second prototype sequence is multiplied by the second sequence in step S320 to obtain the m fifth sequences. A set of the m fifth sequences is the training sequence set. The training sequence set including the fifth sequences obtained in the step has a ZCC characteristic in both the time domain and the frequency domain.

To sum up, the channel estimation method is described in the present application with reference to FIG. 1. In the method, the zero circular convolution sequence set is used as the training sequence set. Under a complex multi-user environment, the channel estimation method provided in the present application can effectively suppress an inter symbol interference between sequences and improve an accuracy of channel estimation. In addition, the construction process of the zero circular convolution sequence provided by the embodiment of the present application is described from the time domain, the frequency domain and the time-frequency mixed domain respectively in the present application with reference to FIG. 2 and FIG. 3. According to a periodic ideal self-correlation characteristic of the zero circular convolution sequence and an ideal cross-correlation characteristic of the zero circular convolution sequence set, this kind of sequence may be widely applied to brainwashing estimation under a multi-user environment.

With reference to FIG. 4, FIG. 4 is a schematic diagram of a channel estimation system provided by an embodiment of the present application. The system 400 includes an acquisition module 410, a training sequence construction module 420, a modulation module 430 and a channel estimation module 440. The acquisition module is configured for acquiring a channel type, and according to the channel type, determining a channel expression, wherein the channel type includes a time selective channel, a frequency selective channel and a time-frequency mixed channel; the channel includes multiple users, and the users transmit information to the channel in a time-sharing and multi-tasking manner. The training sequence construction module is configured for, according to the channel type, determining a training sequence set, wherein a cross-correlation function between any two training sequences in the training sequence set is zero. The modulation module is configured for, according to the channel type, the channel expression and the training sequence set, determining an output sequence. The channel estimation module is configured for, according to the training sequence set and the output sequence, determining an estimation result of the channel.

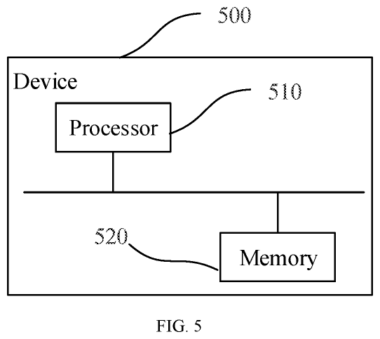

With reference to FIG. 5, FIG. 5 shows a device provided by an embodiment of the present application. The device 500 includes at least one processor 510 and at least one memory 520 for storing at least one program. In FIG. 5, one processor and one memory are provided as an example.

The processor and the memory may be connected by a bus or in other modes. Connection by the bus is taken as an example in FIG. 5.

The memory, as a non-transient computer-readable storage medium, may be used for storing a non-transient software program and a non-transient computer-executable program. In addition, the memory may include a high-speed random access memory, and may also include a non-transient memory, such as at least one disk storage device, flash storage device, or other non-transient solid-state storage devices. In some implementations, the memory may optionally include a memory remotely arranged relative to the processor, and these remote memories may be connected to the device through a network. Examples of the above network include but are not limited to the Internet, the intranet, the local area network, the mobile communication network and a combination thereof.

Another embodiment of the present application also provides a device, the device may be used to execute the control method in any one of the above embodiments, for example, to execute the method steps in FIG. 1 described above.

The device embodiment described above is only illustrative, wherein the units described as separate components may or may not be physically separated, which means that the units may be located in one place or distributed over multiple network units. Some or all of the modules may be selected according to actual needs to achieve the objectives of the solutions in the embodiments.

An embodiment of the present application further discloses a computer storage medium storing a program executable by a processor, wherein the program executable by the processor, when executed by the processor, is configured for implementing the channel estimation method provided by the present application.

Those of ordinary skills in the art may understand that all or some of steps in the method disclosed above and systems may be implemented as software, firmware, hardware and an appropriate combination thereof. Some or all of the physical components may be implemented as software executed by a processor, such as a central processing unit, a digital signal processor or a microprocessor, or implemented as hardware, or implemented as an integrated circuit, such as an application-specific integrated circuit. Such software may be distributed on a computer-readable medium, and the computer-readable medium may include a computer storage medium (or a non-transitory medium) and a communication medium (or a transitory medium). As well known to those of ordinary skills in the art, the term “computer storage medium” includes a volatile and nonvolatile, as well a removable and non-removable medium implemented in any method or technology for storing information (such as a computer readable instruction, a data structure, a program module, or other data). The computer storage media include but are not limited to RAM, ROM, EEPROM, flash storage or other storage technologies, CD-ROM, digital versatile disk (DVD) or other optical disk storage, magnetic box, magnetic tape, magnetic disk storage or other magnetic storage devices, or any other media which can be used to store desired information and accessed by a computer. Furthermore, it is well known to those of ordinary skills in the art that the communication media typically include a computer readable instruction, a data structure, a program module or other data in a modulated data signal such as a carrier wave or other transmission mechanisms, and may include any information delivery medium.

The foregoing describes the preferred embodiments of the present application in detail, but the present application is not limited to the above implementations. Those skilled in the art may further make various equivalent modifications or substitutions without violating the gist of the present application, and these equivalent modifications or substitutions are included in the scope defined by the claims of the present application.

What is claimed is:

1. A channel estimation method, comprising:
acquiring a channel type;
determining a channel expression based on the channel type;
determining a training sequence set based on the channel type;
determining an output sequence based on the channel type, the channel expression and the training sequence set; and
determining an estimation result of a channel according to the training sequence set and the output sequence;
wherein, the channel type comprises at least one of: a time selective channel, a frequency selective channel, or a time-frequency mixed channel;
wherein, the channel is shared by multiple users, and information is transmitted by the users to the channel in at least one of: a time-sharing manner or a multi-tasking manner;
wherein, training sequences in the training sequence set are zero circular convolution sequences, and a cross-correlation function between any two training sequences in the training sequence set is zero.

2. The channel estimation method of claim 1, wherein when the channel type is one of the time selective channel and the frequency selective channel, the determining a training sequence set according to the channel type comprises:
determining a first prototype sequence comprising multiple elements;
performing sequence expansion on the first prototype sequence according to the channel type and determining a first sequence;
acquiring m second sequences with a same length as the first sequence, wherein m is a positive integer;
determining m third sequences according to the channel type, the first sequence and the second sequence, wherein a set of the m third sequences is the training sequence set;
wherein, the first prototype sequence meets the following formula:
Rₛ=E·δ_{P}[p],
wherein s represents the first prototype sequence, P represents a length of the first prototype sequence, P is a positive integer, Rₛ is a self-correlation function of the first prototype sequence, E is an average power of the first prototype sequence s, δ_{L}[l] represents a pulse sequence function with a length of L, and p represents a p^{th} element;
wherein, an expression of the second sequence is as follows:
eₖ={exp(j2πkn/N)}ₙ₌₀^{N-1}, 0≤k≤m−1,
wherein eₖ is a second sequence, j represents an imaginary part of a complex number, k represents a k^{th} element in eₖ, N is a length of the second sequence, N is a positive integer, and a value of n is [0, N−1].

3. The channel estimation method of claim 2, wherein the performing sequence expansion on the first prototype sequence according to the channel type and determining a first sequence comprises:
if the channel type is the time selective channel, stacking the first prototype sequence form times in sequence, and determining the first sequence suitable for the time selective channel; and
if the channel type is the frequency selective channel, respectively adding m−1 zeros after each element of the first prototype sequence, and determining the first sequence suitable for the frequency selective channel.

4. The channel estimation method of claim 2, wherein the determining m third sequences according to the channel type, the first sequence and the second sequence comprises:
if the channel type is the time selective channel, respectively multiplying each component in the first sequence by the second sequence, and determining m third sequences suitable for the time selective channels; and
if the channel type is the frequency selective channel, respectively multiplying each component in a discrete Fourier transform (DFT) of the first sequence by the second sequence, and determining m third sequences suitable for the frequency selective channel.

5. The channel estimation method of claim 2, wherein when the channel type is the time-frequency mixed channel, the determining a training sequence set according to the channel type comprises:
taking the first sequence as a second prototype sequence;
performing sequence expansion on the second prototype sequence according to the channel type and determining a fourth sequence;
acquiring m second sequences with a same length as the fourth sequence; and
determining m fifth sequences according to the fourth sequence and the second sequence, wherein a set of the m fifth sequences is the training sequence set.

6. The channel estimation method of claim 5, wherein determining the m fourth sequences according to the second prototype sequence and the second sequence comprises:
if the second prototype sequence is the first sequence suitable for the frequency selective channel, respectively adding m−1 zeros after each element of the second prototype sequence, and determining the fourth sequence; and
if the second prototype sequence is the first sequence suitable for the time selective channel, stacking the second prototype sequence for m times in sequence, and determining the fourth sequence.

7. The channel estimation method of claim 1, wherein the determining an output sequence according to the channel type, the channel expression and the training sequence set comprises:
if the channel is the time selective channel, inputting a discrete Fourier transform (DFT) of the training sequence into the channel, and determining the output sequence; and
if the channel is the frequency selective channel, inputting the training sequence into the channel, and determining the output sequence.

8. A device, comprising:
at least one processor; and
at least one memory for storing at least one executable program;
wherein the at least one program, when executed by the at least one processor, causes the at least one processor to implement a channel estimation method comprising:
acquiring a channel type;
determining a channel expression according to the channel type;
determining a training sequence set according to the channel type;
determining an output sequence according to the channel type, the channel expression and the training sequence set; and
determining an estimation result of a channel according to the training sequence set and the output sequence;
wherein, the channel type includes at least one of: a time selective channel, a frequency selective channel, or a time-frequency mixed channel;
wherein, the channel is shared by multiple users, and information is transmitted by the users to the channel in at least one of: a time-sharing manner or a multi-tasking manner;
wherein, training sequences in the training sequence set are zero circular convolution sequences, and a cross-correlation function between any two training sequences in the training sequence set is zero.

9. The device of claim 8, wherein when the channel type is one of the time selective channel and the frequency selective channel, the determining a training sequence set according to the channel type comprises:
determining a first prototype sequence comprising multiple elements;
performing sequence expansion on the first prototype sequence according to the channel type and determining a first sequence;
acquiring m second sequences with a same length as the first sequence, wherein m is a positive integer;
determining m third sequences according to the channel type, the first sequence and the second sequence, wherein a set of the m third sequences is the training sequence set;
wherein, the first prototype sequence meets the following formula:
Rₛ=E·δ_{P}[p],
wherein s represents the first prototype sequence, P represents a length of the first prototype sequence, P is a positive integer, Rₛ is a self-correlation function of the first prototype sequence, E is an average power of the first prototype sequence s, δ_{L}[l] represents a pulse sequence function with a length of L, and p represents a p^{th} element;
wherein, an expression of the second sequence is as follows:
eₖ={exp(j2πkn/N)}ₙ₌₀^{N-1}, 0≤k≤m−1,
wherein eₖ is a second sequence, j represents an imaginary part of a complex number, k represents a k^{th} element in eₖ, N is a length of the second sequence, N is a positive integer, and a value of n is [0, N−1].

10. The device of claim 9, wherein the performing sequence expansion on the first prototype sequence according to the channel type and determining a first sequence comprises:
if the channel type is the time selective channel, stacking the first prototype sequence form times in sequence, and determining the first sequence suitable for the time selective channel; and
if the channel type is the frequency selective channel, respectively adding m−1 zeros after each element of the first prototype sequence, and determining the first sequence suitable for the frequency selective channel.

11. The device of claim 9, wherein the determining m third sequences according to the channel type, the first sequence and the second sequence comprises:
if the channel type is the time selective channel, respectively multiplying each component in the first sequence by the second sequence, and determining m third sequences suitable for the time selective channels; and
if the channel type is the frequency selective channel, respectively multiplying each component in a discrete Fourier transform (DFT) of the first sequence by the second sequence, and determining m third sequences suitable for the frequency selective channel.

12. The device of claim 9, wherein when the channel type is the time-frequency mixed channel, the determining a training sequence set according to the channel type comprises:
taking the first sequence as a second prototype sequence;
performing sequence expansion on the second prototype sequence according to the channel type and determining a fourth sequence;
acquiring m second sequences with a same length as the fourth sequence; and
determining m fifth sequences according to the fourth sequence and the second sequence, wherein a set of the m fifth sequences is the training sequence set.

13. The device of claim 12, wherein determining them fourth sequences according to the second prototype sequence and the second sequence comprises:
if the second prototype sequence is the first sequence suitable for the frequency selective channel, respectively adding m−1 zeros after each element of the second prototype sequence, and determining the fourth sequence; and
if the second prototype sequence is the first sequence suitable for the time selective channel, stacking the second prototype sequence for m times in sequence, and determining the fourth sequence.

14. The device of claim 8, wherein the determining an output sequence according to the channel type, the channel expression and the training sequence set comprises:
if the channel is the time selective channel, inputting a discrete Fourier transform (DFT) of the training sequence into the channel, and determining the output sequence; and
if the channel is the frequency selective channel, inputting the training sequence into the channel, and determining the output sequence.

15. A computer storage medium storing a program executable by a processor, wherein the program executable by the processor, when executed by the processor, is configured for implementing a channel estimation method comprising:
acquiring a channel type;
determining a channel expression according to the channel type;
determining a training sequence set according to the channel type;
determining an output sequence according to the channel type, the channel expression and the training sequence set; and
determining an estimation result of a channel according to the training sequence set and the output sequence;
wherein, the channel type includes at least one of: a time selective channel, a frequency selective channel, or a time-frequency mixed channel;
wherein, the channel is shared by multiple users, and information is transmitted by the users to the channel in at least one of: a time-sharing manner or a multi-tasking manner;
wherein, training sequences in the training sequence set are zero circular convolution sequences, and a cross-correlation function between any two training sequences in the training sequence set is zero.

16. The computer storage medium of claim 15, wherein when the channel type is one of the time selective channel and the frequency selective channel, the determining a training sequence set according to the channel type comprises:
determining a first prototype sequence comprising multiple elements;
performing sequence expansion on the first prototype sequence according to the channel type and determining a first sequence;
acquiring m second sequences with a same length as the first sequence, wherein m is a positive integer;
determining m third sequences according to the channel type, the first sequence and the second sequence, wherein a set of the m third sequences is the training sequence set;
wherein, the first prototype sequence meets the following formula:
Rₛ=E·δ_{P}[p],
wherein s represents the first prototype sequence, P represents a length of the first prototype sequence, P is a positive integer, Rₛ is a self-correlation function of the first prototype sequence, E is an average power of the first prototype sequence s, δ_{L}[l] represents a pulse sequence function with a length of L, and p represents a p^{th} element;
wherein, an expression of the second sequence is as follows:
eₖ={exp(j2πkn/N)}ₙ₌₀^{N-1}, 0≤k≤m−1,
wherein eₖ is a second sequence, j represents an imaginary part of a complex number, k represents a k^{th} element in eₖ, N is a length of the second sequence, N is a positive integer, and a value of n is [0, N−1].

17. The computer storage medium of claim 16, wherein the performing sequence expansion on the first prototype sequence according to the channel type and determining a first sequence comprises:
if the channel type is the time selective channel, stacking the first prototype sequence form times in sequence, and determining the first sequence suitable for the time selective channel; and
if the channel type is the frequency selective channel, respectively adding m−1 zeros after each element of the first prototype sequence, and determining the first sequence suitable for the frequency selective channel.

18. The computer storage medium of claim 16, wherein the determining m third sequences according to the channel type, the first sequence and the second sequence comprises:
if the channel type is the time selective channel, respectively multiplying each component in the first sequence by the second sequence, and determining m third sequences suitable for the time selective channels; and
if the channel type is the frequency selective channel, respectively multiplying each component in a discrete Fourier transform (DFT) of the first sequence by the second sequence, and determining m third sequences suitable for the frequency selective channel.

19. The computer storage medium of claim 16, wherein when the channel type is the time-frequency mixed channel, the determining a training sequence set according to the channel type comprises:
taking the first sequence as a second prototype sequence;
performing sequence expansion on the second prototype sequence according to the channel type and determining a fourth sequence;
acquiring m second sequences with a same length as the fourth sequence; and
determining m fifth sequences according to the fourth sequence and the second sequence, wherein a set of the m fifth sequences is the training sequence set.

20. The computer storage medium of claim 19, wherein determining the m fourth sequences according to the second prototype sequence and the second sequence comprises:
if the second prototype sequence is the first sequence suitable for the frequency selective channel, respectively adding m−1 zeros after each element of the second prototype sequence, and determining the fourth sequence; and
if the second prototype sequence is the first sequence suitable for the time selective channel, stacking the second prototype sequence for m times in sequence, and determining the fourth sequence.
